(19) United States
(12) Patent Application Publication
(10) Pub. No.: US 2010/0231672 A1
(43) Pub. Date: Sep. 16, 2010

(54) Method of improving the electrical conductivity of a conductive ink trace pattern and system therefor

(76) Inventors: Margaret Joyce, Kalamazoo, MI (US); Paul D. Fleming, Kalamazoo, MI (US); Sujay Prabhakar Pandkar, Euless, TX (US)

Correspondence Address: FLYNN THIEL BOUTELL & TANIS, P.C., 2026 RAMBLING ROAD, KALAMAZOO, MI, 49008-1631, US

(21) Appl. No.: 12/381,527

(22) Filed: Mar. 12, 2009

(51) Int. Cl. B41J 2/01; B41F 31/00

(52) U.S. Cl. 347/102; 101/491

(57) ABSTRACT

A method and system for improving the electrical conductivity of a conductive ink trace pattern provided on a substrate involves the printing of a conductive ink on a substrate to form a trace pattern thereon, fixing the trace pattern to the substrate and performing calendering on the substrate having the trace pattern fixed thereto.

### FIELD OF THE INVENTION

The present invention is concerned with the provision of a conductive ink trace pattern on a substrate and, more particularly, to a method and system for improving the electrical conductivity of a conductive ink trace pattern provided on a substrate.

### BACKGROUND OF THE INVENTION

Electrically conductive inks are being used more and more to form conductive circuits on a substrate. Flexible substrates having circuits formed thereon from electrically conductive ink have been used in many applications, such as automobile dashboards, appliance control panels, aircraft backlit panels, computers and in radio frequency identification (RFID) technology. Various types of printing processes have been used to print the electrically conductive ink on the substrate such as silk screen printing, ink jet printing, laser printing, rotogravure printing flexographic printing and lithographic printing. However, whatever method is used to print the electroconductive ink, there exists a common problem of poor ink transfer due to surface roughness and poor conductivity due to insufficient drying or curing to the ink film. The ink having satisfactory adhesion to the substrate on which it is printed can also be problematic.

Calendering is a process used in the paper industry to improve the smoothness of paper and paperboard. A calendar is made up of a number of rolls arranged to form multiple nips, based on the desired smoothness of the finished product. The rolls can be of different hardnesses and are capable of being heated. In the calendering process, a paper is pressed against a polished metal cylinder with enough force to replicate the surface of the polished roll through plastic deformation of the paper. Through the control of the roll hardness, pressure, temperature, number of nips and surface finish on the hard rolls, the surface finish and amount of sheet compaction, or density, can be controlled without adversely affecting the paper product's strength properties. It is known to heat the calender rolls in order to produce a desired surface finish at lower pressures and with fewer nips due to the fibers and binders softening and becoming more pliable. Most calendering is performed on-line using a combination of heated metal and soft covered rolls which is known as hot-soft nip calendering. However, to date, calendering has not been used to treat a substrate having an electrically conductive ink trace provided thereon to improve the properties thereof.

### BRIEF SUMMARY OF THE INVENTION

The present invention provides a method and system of improving the conductivity of an electrically conductive ink trace fixed on a substrate by subjecting the substrate having the trace fixed thereto to a calendering step. The calendering step aids in drying or curing and smoothing the electroconductive ink trace on the substrate and improves the conductivity of the ink trace in an expedient and inexpensive manner.

### BRIEF DESCRIPTION OF THE DRAWINGS

FIG. 1 is a schematic drawing illustrating the process and system of the present invention.

FIG. 2 is a chart illustrating the effect of different factors on the sheet resistivity.

FIG. 3 is a chart showing the interaction of different factors on the sheet resistivity.

FIG. 4 is a chart showing the effect of different factors on the surface roughness of the substrate.

FIG. 5 is a chart showing the interaction of different factors on the surface roughness of the substrate.

### DETAILED DESCRIPTION OF THE INVENTION

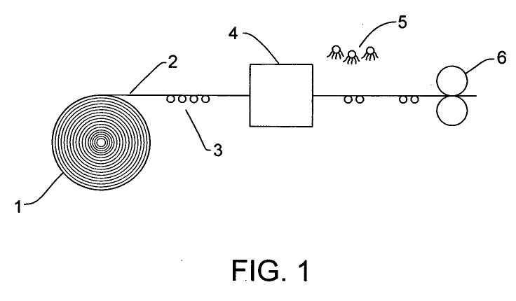

As illustrated in FIG. 1, the present invention involves the transport of a substrate 2 from a roll 1 by any suitable method such as or tension to a printing station 4 where a trace of an electrically conductive ink is deposited on the substrate. The substrate 2 having the electrically conductive ink provided thereon then passes through a fixing means 5 where the electrically conductive ink trace is fixed to the substrate 2 and then passes through the calender 6. Although the substrate 2 is shown in FIG. 1 as being provided in the form of a roll 1, the presently claimed invention is not limited thereto and the substrate 2 can be provided in the form of individual sheets.

The substrate used in the present invention is not particularly limited and can be made of any material that is typically used as a substrate on which an electrically conductive ink trace is provided thereon, such as a polyalkylene, a polyester, an ethylene copolymer, a polyurethane, a fluorocarbon polymer, polyacrylonitrile, a cellulosic polymer, coated or uncoated paper stock, synthetic paper, paperboard, polystyrene, polyvinyl chloride, a polycarbonate, a metallized polymer film, and combinations thereof. Although the advantages of the present invention are more realized with a flexible substrate 2, the present invention is not limited thereto and a rigid substrate can also be used.

The electrically conductive ink contains at least one conductive material, which may be a particulate material ranging from nearly spherical to flake-like particles or dissolved material. The conductive material is preferably present in the ink in an amount of from 5 to about 90% by weight and can be a conductive metal oxide material such as antimony tin oxide and indium tin oxide powders. Additionally, conductive metal particles can serve as the conductive material with the metals in Group IV of the periodic table, metallic silver, metallic aluminum, metallic copper, metallic gold, metallic platinum, and conductive alloys such as bronze being used, as well as a particulate material coated with these metals. Additionally, conductive carbon, a conductive polymer and conductive metal salts can serve as a conductive material in the electrically conductive inks used in the present invention. Also, known colorants and fillers can be provided in the electrically conductive ink as long as it does not interfere with the properties of the ink.

As shown in FIG. 1, electrically conductive ink is printed on the substrate 2 at a printing station 4. The method of forming the electrically conductive trace on the substrate 2 at the printing station is not critical and can be applied by any suitable printing process such as flexography, rotogravure printing, lithography, screen printing and ink jet printing. The printing station 4 is chosen based on the properties of the substrate 2 and the electrically conductive ink.

As discussed previously, the electrically conductive ink can either be water-based, solvent-based or an ink that is curable by radiation, such as ultraviolet radiation. When the electrically conductive ink is a water-based or solvent-based ink, the fixing means 5 is a dryer for evaporating the water or the solvent from the ink to fix the electrically conductive ink trace to the substrate 2. If the electrically conductive ink is a radiation-curable ink, then the fixing means 5 is a source for providing the radiation such as an ultraviolet lamp.

After leaving the fixing means 5, the substrate 2 having electrically conductive ink trace fixed thereto is then transported to a calendering station where it passes between the nips of rollers. The calender can be provided with rolls operated with a desired hardness, pressure, temperature and number of nips. Either hard rolls, soft rolls or a combination thereof can be used in the present invention. A particular preferred method of calendering is hot-embossing calendering. The temperature of operation of the rolls is dependent on the ink and substrate type and the upper limit of the temperature for calendering is the temperature at which the substrate or ink begins to degrade or adhere to the calendering roll. A desirable range is between 20 and 110° C., more preferably between 40 and 80° C. The pressure between the nips of the rolls is likewise determined based on the ink and substrate types and the end product. The higher the pressure, the greater the increase in conductivity of the electroconductive ink trace on the substrate, unless the mechanical integrity of the substrate or ink film are compromised. This is believed to be due to the increase in smoothness of the ink traces and compaction thereof thereby increasing contact between the conductive material contained in the electrically conductive ink. As such, the pressure used in the present invention is based on economics with a range of from 100 to 2,000 pounds per linear inch being preferred and a range between 300 to 1,500 pounds per linear inch being more preferred.

In order to enable one of ordinary skill in the art to better practice the invention, the following example is given by way of illustration, and not by way of limitation. All parts are by weight unless indicated otherwise.

### Example

Conductive inks were printed using a Comco Commander narrow-web flexographic press. For this study, three packaging papers were selected. The first was a heat seal pouch paper (Sub1), the second was a beer bottle label paper (Sub2) and the third was a thermal transfer barcode paper (Sub3). Two ink systems were used in order to compare how different inks perform at different calendering conditions. Water-based, WB, and solvent-based, SB, silver-flake conductive inks were used. The printing design included lines at 4 different tones, 70, 80, 90 and 100%. A 90% tone trace was printed in both, machine and cross direction. Moreover, 50 mm×35 mm rectangles at 90 and 100% tones were included to enable sufficient area for measurements of printed ink film roughness. The Alien Technology UHF RFID tag “squiggle” (2^{nd} generation) antenna design was also printed at 90 and 100% tone. To ensure sufficient drying, three dryers were used during printing, all set to 107° C. A 12 BCM (Billion cubic microns per square inch, equivalent to 18.6 μm) and 200 lpi (lines per inch) anilox was used.

Calendering followed a DOE (design of experiment), more specifically, multilevel full factorial DOE was used. Four factors were used, ink type, substrate type, calendering temperature and calendering pressure. The three substrates were printed with two different inks, SB and WB, were calendered at three different pressures, not calendered and four different temperatures, resulting in 16 different calendering conditions for each ink and substrate. The levels for temperature and pressure are outlined in Table 1. The samples were found to stick to the hot metal calendering roll at 80° C., so the temperature levels were limited to a maximum temperature of 75° C. Five replicates were performed for each condition.

TABLE 1
Two factors and their levels used in calendering study

| Temperature (° C.) | Pressure (PLI) |
|---|---|
| 23 | Not Calendered |
| 50 | 375 |
| 65 | 950 |
| 75 | 1500 |

A sheet-fed, hot soft-nip calender was used to calender the samples. The electrical properties of the printed traces were measured before and after calendering in terms of resistance (R) and reactance (X), using an Agilent 4338B milliohmmeter at a low frequency (1 kHz). These values were then used to calculate the AC impedance of the traces.

An ImageXpert image analysis system was employed to measure line length, width and raggedness. The line width and raggedness for each printed trace was measured at 5 different places and the average was recorded. Line length was measured twice and the average compared to the original 50 mm to determine the line length gain. The line length and line width values were then used to calculate the AC sheet impedance.

An Olympus microscope in combination with a CCD camera giving a total magnification of 1000× and software Pax-it were used to measure the ink film thickness (IFT), which was further used to calculate bulk resistivity.

An Emveco 210R Electronic Microgage (stylus profilometer) was used to measure the roughness of the printed ink films before and after calendering. TAPPI ‘T575 om-07’ standard was followed to set the parameters on the testing instrument.

All the printed samples were measured for AC impedance before calendering. Results of sheet resistivity for all tested factors and their levels were statistically analyzed using ANOVA (analysis of variance) analysis in Minitab 15 software. In ANOVA analysis, a factor is considered statistically significant if its p-value is lower than the chosen level of significance (a), in this case it was 5% or 0.05, corresponding to a 95% confidence limit. Table 2 shows the ANOVA results for sheet resistivity and effects of tested factors and their interactions.

The sheet resistivity and bulk resistivity are calculated from the raw resistance of an electrically conducting trace. It is assumed that the trace is printed on a substrate and it has width w, length l and thickness t. More details are given elsewhere.

### Sheet Resistivity Calculation

The DC resistance values from the Keithly 2400 and measured trace dimensions obtained from the evaluation of the samples using image analysis were combined to calculate the sheet resistivity, R_{SH}, of the printed lines according to:

$${R}_{SH} = R \frac{w}{l}$$

where: R_{SH} is sheet resistivity in Ω sq⁻¹,
R is the measure line resistance in Ω,
w is the measured line width in μm,
l is measured line length in μm.

### Bulk Resistivity Calculation

If the sheet resistivity value is multiplied by the ink film thickness, a bulk resistivity, ρ_{DC}, is obtained. The bulk resistivity is calculated according to:

$${ρ}_{DC} = R \frac{w}{l} t$$

where: ρ_{DC} is bulk resistivity in Ω μm,
R is line resistance in Ω,
w is line width in μm,
t is line thickness in μm.

TABLE 2
ANOVA results for Sheet resistivity (Ω/sq) versus Substrate,
Inc, Line tone, Temperature (° C.) and Pressure (PLI).
Analysis of Variance for Sheet Resistivity (Ω/sq)

| Source | DF | SS | MS | F | P |
|---|---|---|---|---|---|
| Ink | 1 | 0.230638 | 0.230638 | 328.53 | 0.000 |
| Substrate | 2 | 0.094300 | 0.047150 | 67.16 | 0.000 |
| Line Tone | 2 | 0.825764 | 0.412882 | 588.13 | 0.000 |
| Temperature (° C.) | 3 | 0.447112 | 0.149037 | 212.30 | 0.000 |
| Pressure (PLI) | 3 | 0.009146 | 0.003049 | 4.34 | 0.005 |
| Ink*Substrate | 2 | 0.026439 | 0.013219 | 18.83 | 0.000 |
| Ink*Line Tone | 2 | 0.143487 | 0.071743 | 102.19 | 0.000 |
| Ink*Temperature (° C.) | 3 | 0.062618 | 0.020873 | 29.73 | 0.000 |
| Ink*Pressure (PLI) | 3 | 0.052459 | 0.017486 | 24.91 | 0.000 |
| Substrate*Line Tone | 4 | 0.023009 | 0.005752 | 8.19 | 0.000 |
| Substrate*Temperature | 6 | 0.014219 | 0.002370 | 3.38 | 0.003 |
| (° C.) | | | | | |
| Substrate*Pressure | 6 | 0.001522 | 0.000254 | 0.36 | 0.903 |
| (PLI) | | | | | |
| Line Tone*Temperature | 6 | 0.002498 | 0.000416 | 0.59 | 0.736 |
| (° C.) | | | | | |
| Line Tone*Pressure | 6 | 0.008632 | 0.001439 | 2.05 | 0.060 |
| (PLI) | | | | | |
| Temperature (° C.)* | 9 | 0.013681 | 0.001520 | 2.17 | 0.025 |
| Pressure (PLI) | | | | | |
| Error | 229 | 0.160764 | 0.000702 | | |
| Total | 287 | 2.116287 | | | |

### S=0.0264958 R²=92.40% Rₐ²=90.48%

The p-values found for each main effect and many of their interactions are below 0.05, therefore it can be concluded that all of the factors significantly affect sheet resistivity.

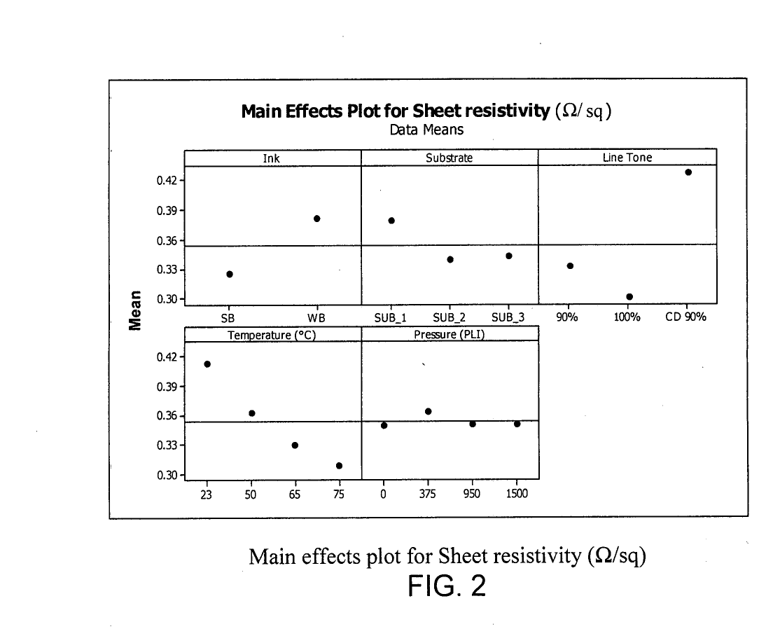

FIG. 2 shows a plot in which each tested factor is considered individually to assess the overall effect of individual factors on bulk resistivity. As shown in FIG. 2, solvent-based ink had a significantly lower bulk resistivity as compared to water-based ink and an increase in temperature of the calendering temperature also resulted in a marked reduction in bulk resistivity.

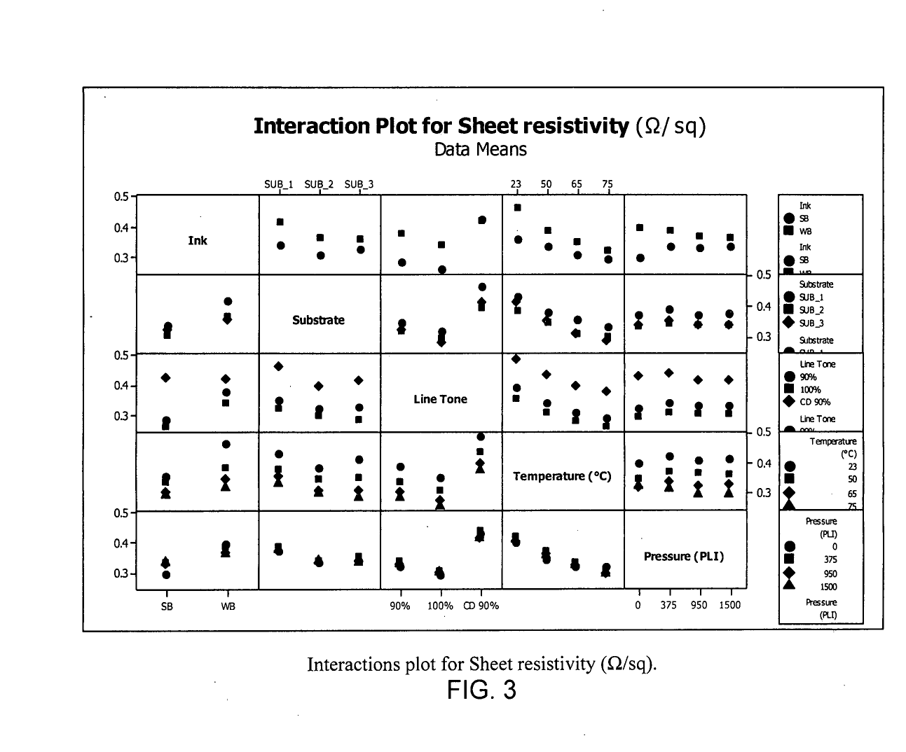

FIG. 3 is an interaction plot for sheet resistivity for the type of ink, substrate, line tone, calendering temperature and calendering pressure. As shown in FIG. 3, increasing the temperature gradually reduced the sheet resistivity for both water-based and solvent-based inks and, in the case of the ink and pressure interaction plot, a significant gradual decrease in sheet resistivity is observed for water-based ink with an increasing pressure. For both types of ink, the combination of pressure and temperature reduced the resistivity of the samples.

Results for ink film roughness were also analyzed using ANOVA analysis and the results are presented in Table 3.

TABLE 3
ANOVA results for Ink Film Roughness (μm) versus Substrate,
Ink, Line tone, Temperature (° C.) and Pressure (PLI)
Analysis of Variance for Roughness (microns)

| Source | DF | SS | MS | F | P |
|---|---|---|---|---|---|
| Ink | 1 | 2.12218 | 2.12218 | 1469.05 | 0.000 |
| Substrate | 2 | 0.54324 | 0.27162 | 188.03 | 0.000 |
| Line Tone | 2 | 0.52578 | 0.26289 | 181.98 | 0.000 |
| Temperature (° C.) | 3 | 0.56834 | 0.18945 | 131.14 | 0.000 |
| Pressure (PLI) | 3 | 1.44850 | 0.48283 | 334.24 | 0.000 |
| Ink*Substrate | 2 | 0.40467 | 0.20234 | 140.06 | 0.000 |
| Ink*Line Tone | 2 | 0.09252 | 0.04626 | 32.02 | 0.000 |
| Ink*Temperature (° C.) | 3 | 0.11569 | 0.03856 | 26.70 | 0.000 |
| Ink*Pressure (PLI) | 3 | 0.42085 | 0.14028 | 97.11 | 0.000 |
| Substrate*Line Tone | 4 | 0.03516 | 0.00879 | 6.08 | 0.000 |
| Substrate*Temperature | 6 | 0.00462 | 0.00077 | 0.53 | 0.783 |
| (° C.) | | | | | |
| Substrate*Pressure | 6 | 0.00714 | 0.00119 | 0.82 | 0.553 |
| (PLI) | | | | | |
| Line Tone*Temperature | 6 | 0.02545 | 0.00424 | 2.94 | 0.009 |
| (° C.) | | | | | |
| Line Tone*Pressure | 6 | 0.02256 | 0.00376 | 2.60 | 0.018 |
| (PLI) | | | | | |
| Temperature (° C.)* | 9 | 0.33622 | 0.03736 | 25.86 | 0.000 |
| Pressure (PLI) | | | | | |
| Error | 229 | 0.33081 | 0.00144 | | |
| Total | 287 | 7.00374 | | | |

### S=0.0380078 R²=95.28% Rₐ²=94.08%

Similarly to sheet resistivity, p-values were found below 0.05 for all tested factors and many of their interactions; hence all significantly affect roughness of printed ink films.

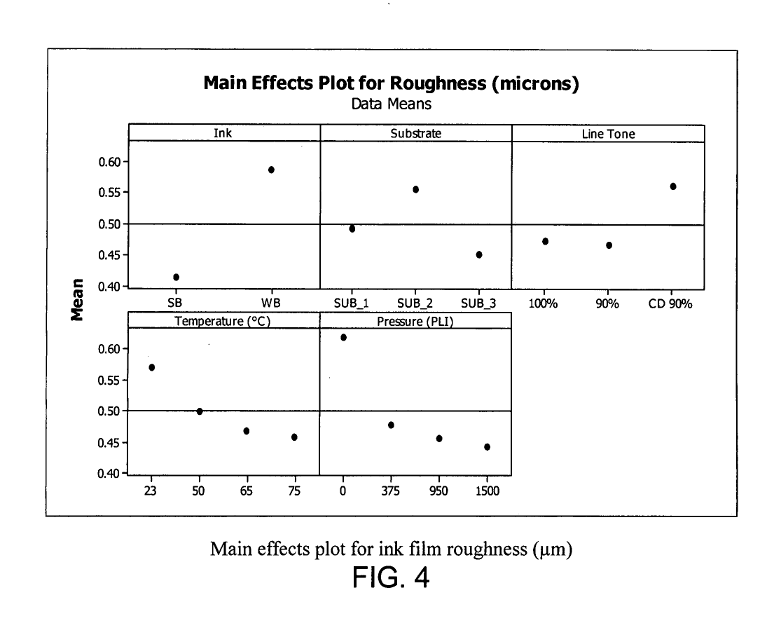

FIG. 4 is a main effects plot for ink film roughness and illustrates that the solvent-based ink typically showed overall lower roughness values as compared to the water-based ink and an increase in temperature and pressure resulted in significantly lower roughness values.

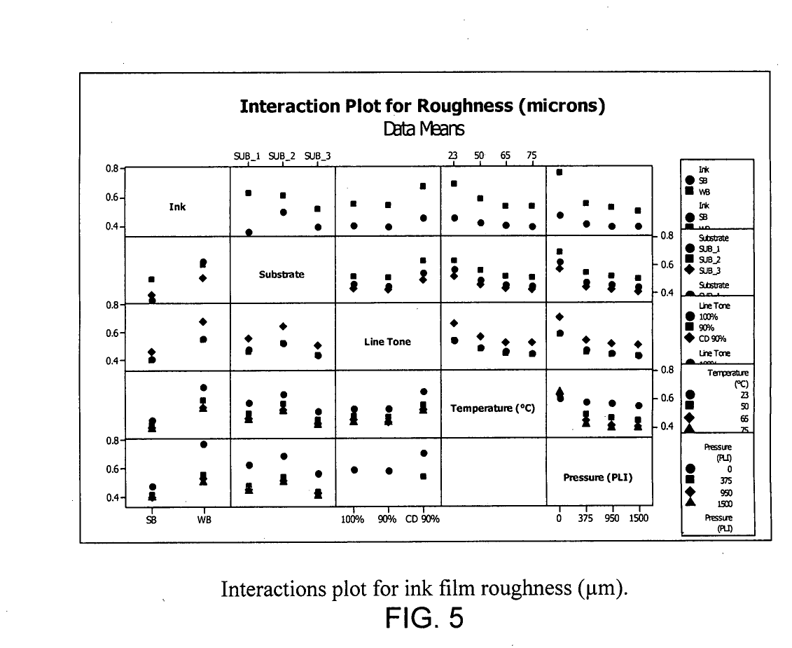

FIG. 5 is an interaction plot for ink film roughness using the ink type, substrate type, line tone, calendering temperature and calendering pressure. As shown in FIG. 5 for the ink-temperature and ink-pressure interaction, an increasing temperature or pressure of the calendering reduces the roughness. The combination of temperature and pressure interaction illustrates that a higher pressure and temperature condition results in a lower roughness. The smoothing of the printed ink film from calendering is beneficial when additional functional layers are printed.

What is claimed is:

1. A method of improving the electrical conductivity of a conductive ink trace pattern provided on a substrate, comprising the steps of:
printing a conductive ink on a substrate to form a trace pattern thereon;
fixing the trace pattern to the substrate; and
perform calendering on the substrate having the trace pattern fixed thereto to improve the electrical conductivity of the trace pattern.

2. The method of claim 1, wherein the conductive ink is printed on the substrate by a printing process selected from the group consisting of flexography, rotogravure, lithography, screen and ink jet printing.

3. The method of claim 1, wherein the conductive ink is a solvent-based ink or a water-based ink.

4. The method of claim 1, wherein the conductive ink contains at least one member selected from the group consisting of a conductive metal, conductive carbon, a conductive polymer and a conductive metal salt.

5. The method of claim 4, wherein the conductive ink contains a conductive metal selected from the group consisting of gold, silver, platinum and copper.

6. The method of claim 1, wherein the substrate is made of a material selected from the group consisting of a polyalkylene, a polyester, an ethylene copolymer, a polyurethane, a fluorocarbon polymer, polyacrylonitrile, a cellulosic polymer, coated or uncoated paper stock, synthetic paper, paperboard, polystyrene, polyvinyl chloride, a polycarbonate, a metallized polymer film, and combinations thereof.

7. The method of claim 1, wherein the calendering is performed by a calendering method selected from the group consisting of hard-nip calendering, soft-nip calendering, and combinations thereof.

8. The method of claim 7, wherein the calendering is performed by a hot soft-nip calender.

9. The method of claim 1, wherein the calendering is performed by a hot embossing method.

10. The method of claim 1, wherein a plurality of substrates having a trace pattern fixed thereto are formed into a laminate and then passed through the calender.

11. The method of claim 1, wherein the temperature range of the calendering is from 20-110° C. and the pressure range 100-2,000 PLI.

12. The method of claim 11, wherein the temperature range of the calendering is from 40-80° C. and the pressure range 300-1,500 PLI.

13. An inline printing system comprising a feeder for feeding a substrate, a printer for receiving the fed substrate and printing a conductive ink thereon, a fixing means for fixing the conductive ink to the substrate and a calender for receiving the substrate having the conductive ink fixed thereto and performing calendering thereon.

14. The inline printing system of claim 13, wherein the printer is a flexographic printer, a rotogravure printer, a lithographic printer, a screen printer or an ink jet printer.

15. The inline printing system of claim 13, wherein the fixing means is a drier or an ultraviolet light source.

16. The inline printing system of claim 13, wherein the calender is a hard-nip calender, a soft-nip calender or a combination thereof.
